(19) United States
(12) Patent Application Publication
(10) Pub. No.: US 2026/0296225 A1
(43) Pub. Date: Oct. 1, 2026

(54) FUEL CELL VEHICLE AND REGENERATIVE ELECTRICAL POWER CONSUMPTION METHOD FOR FUEL CELL VEHICLE

(71) Applicant: HONDA MOTOR CO., LTD., TOKYO (JP)

(72) Inventor: Kohei YOSHIDA, WAKO-SHI (JP)

(21) Appl. No.: 19/578,403

(22) Filed: Mar. 25, 2026

(30) Foreign Application Priority Data
Mar. 27, 2025 (JP) 2025-052937

(51) Int. Cl. B60L 50/72; B60L 1/00; B60L 7/18; B60L 15/00; B60L 58/34; H01M 8/04537; H01M 8/04858; H01M 10/46; H01M 16/00

(52) U.S. Cl. CPC B60L 50/72; B60L 1/003; B60L 7/18; B60L 15/007; B60L 58/34; H01M 8/04626; H01M 8/04888; H01M 10/46; H01M 16/006; H01M 2220/20; H01M 2250/20; H01M 2250/405

(57) ABSTRACT

A fuel cell vehicle includes auxiliary devices driven via inverters to which a DC terminal motoring voltage of a drive motor during motoring operation or a DC terminal regenerative voltage during regenerative operation is applied. The DC terminal regenerative voltage obtained by converting an AC terminal regenerative voltage generated in a drive motor during regenerative operation is increased to a high regenerative voltage by a step-up converter or a step-up/step-down converter. The high regenerative electrical voltage is applied to the auxiliary devices via the inverters, and increases the switching loss of the switching elements constituting the inverters.

### CROSS-REFERENCE TO RELATED APPLICATIONS

This application is based upon and claims the benefit of priority from Japanese Patent Application No. 2025-052937 filed on Mar. 27, 2025, the contents of which are incorporated herein by reference.

### BACKGROUND OF THE INVENTION

### Field of the Invention

The present disclosure relates to a fuel cell vehicle equipped with a fuel cell and a method of consuming regenerative electrical power of a drive motor of the fuel cell vehicle.

### Description of the Related Art

In recent years, research and development have been conducted on fuel cells (FCs) that contribute to energy efficiency in order to ensure that more people have access to affordable, reliable, sustainable and modern energy.

For example, JP 2017-135860 A discloses a fuel cell system including a drive motor that is driven by electrical power from at least one of a fuel cell and a secondary battery and is capable of performing a regenerative operation, and an auxiliary device that is capable of consuming regenerative electrical power from the drive motor. In the fuel cell system, if electrical power to be charged to the secondary battery is higher than a predetermined threshold for electrical power to be charged and a load of the secondary battery reaches a predetermined load threshold, the auxiliary device starts an operation of consuming the regenerative electrical power.

### SUMMARY OF THE INVENTION

However, in a situation where there is no room for charging the secondary battery with the regenerated electrical energy, if the regenerative electrical power is higher than the regenerative electrical power that can be consumed by the auxiliary machine, there is a problem that the surplus regenerative electrical power cannot be properly dumped. The present disclosure has the object of solving the aforementioned problem.

One aspect of the present disclosure is a fuel cell vehicle including a direct-current-to-alternating-current converter, a fuel cell, a step-up converter configured to increase a generated voltage of the fuel cell to generate a motoring voltage at a direct-current terminal of the direct-current-to-alternating-current converter, a power storage device, a step-up and step-down converter configured to increase a power storage voltage of the power storage device to generate a motoring voltage at the direct-current terminal, and a drive motor configured to perform motoring operation upon application of a motoring voltage at an alternating-current terminal obtained by converting the motoring voltage at the direct-current terminal into the motoring voltage at the alternating-current terminal by the direct-current-to-alternating-current converter, wherein the fuel cell vehicle charges the power storage device with the regenerative voltage at the direct-current terminal that is converted from a regenerative voltage at the alternating-current terminal generated at the drive motor during regenerative operation through the direct-current-and-alternating-current converter and decreased by the step-up and step-down converter, or with a voltage at the direct-current terminal that is increased from the generated voltage by the step-up converter and decreased by the step-up and step-down converter, the fuel cell vehicle includes an auxiliary device driven via an inverter to which the motoring voltage at the direct-current terminal during the motoring operation or the regenerative voltage at the direct-current terminal during the regenerative operation is applied, wherein during the regenerative operation, the regenerative voltage generated at the alternating-current terminal of the drive motor is converted, through the direct-current-and-alternating-current converter, into a regenerative voltage at the direct-current terminal, and increased by the step-up converter or the step-up and step-down converter to a high regenerative voltage that is higher than the regenerative voltage at the direct-current terminal, and the high regenerative voltage is applied to the inverter configured to drive the auxiliary device.

Another aspect of the present disclosure is a regenerative electrical power consumption method for a fuel cell vehicle including a direct-current-to-alternating-current converter, a fuel cell, a step-up converter configured to increase a generated voltage of the fuel cell to generate a motoring voltage at a direct-current terminal of the direct-current-to-alternating-current converter, a power storage device, a step-up and step-down converter configured to increase a power storage voltage of the power storage device to generate a motoring voltage at the direct-current terminal, and a drive motor configured to perform motoring operation upon application of a motoring voltage at an alternating-current terminal obtained by converting the motoring voltage at the direct-current terminal into the motoring voltage at the alternating-current terminal by the direct-current-to-alternating-current converter, wherein the fuel cell vehicle charges the power storage device with the regenerative voltage at the direct-current terminal that is converted from a regenerative voltage at the alternating-current terminal generated at the drive motor during regenerative operation through the direct-current-and-alternating-current converter and decreased by the step-up and step-down converter, or with a voltage at the direct-current terminal that is increased from the generated voltage by the step-up converter and decreased by the step-up and step-down converter, the fuel cell vehicle includes an auxiliary device driven via an inverter to which the motoring voltage at the direct-current terminal during the motoring operation or the regenerative voltage at the direct-current terminal during the regenerative operation is applied, the method comprising: a high regenerative voltage generation step of converting, during the regenerative operation, through the direct-current-and-alternating-current converter, the regenerative voltage generated at the alternating-current terminal of the drive motor into a regenerative voltage at the direct-current terminal and increasing the regenerative voltage at the direct-current terminal to a high regenerative voltage that is higher than the regenerative voltage at the direct-current terminal; and an auxiliary device drive step of driving the auxiliary device by applying the high regenerative voltage to the inverter to increase a switching loss of the inverter.

According to the present disclosure, the regenerative voltage (regenerative voltage at the alternating-current terminal) generated by the drive motor is increased to the high regenerative voltage at the direct-current terminal by the step-up converter or the step-up/step-down converter, and the high regenerative voltage at the direct-current terminal is applied to the inverter that drives the auxiliary device. Here, the high regenerative voltage at the direct-current terminal refers to a DC voltage higher than a normal DC terminal regenerative voltage obtained by converting, by the DC/AC converter, the AC terminal regenerative voltage generated by the drive motor during regenerative operation. Thus, since the high regenerative voltage at the DC terminal is applied to the DC terminal of the switching element of the inverter for driving the auxiliary device, the loss of the switching elements constituting the inverter increases, and this loss enables accurate curtailment of the surplus regenerative electrical power that cannot be charged into the power storage device. As a result, the regenerative brake by the drive motor can be efficiently applied.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a fuel cell vehicle according to an embodiment in which a fuel cell system is incorporated;

FIG. 2 is a schematic electric circuit diagram of the fuel cell vehicle showing an example of the circuit configuration of a step-up converter, a step-up/step-down converter, and a DC/AC converter in the fuel cell vehicle shown in FIG. 1;

FIG. 3 is a flowchart for explaining the fuel cell vehicle and the regenerative electrical power consumption method for the fuel cell vehicle according to the embodiment;

FIG. 4 is a schematic diagram illustrating a remaining capacity of the power storage device;

FIG. 5A is an explanatory diagram of switching loss in the case that an inverter that drives an auxiliary device is operated by applying a regenerative voltage at a DC terminal to a switching element of the inverter; and FIG. 5B is an explanatory diagram of switching loss in the case that the inverter is operated by applying a high regenerative voltage at the DC terminal increased from there generative voltage at the DC terminal.

### DETAILED DESCRIPTION OF THE INVENTION

### Embodiment

### Configuration

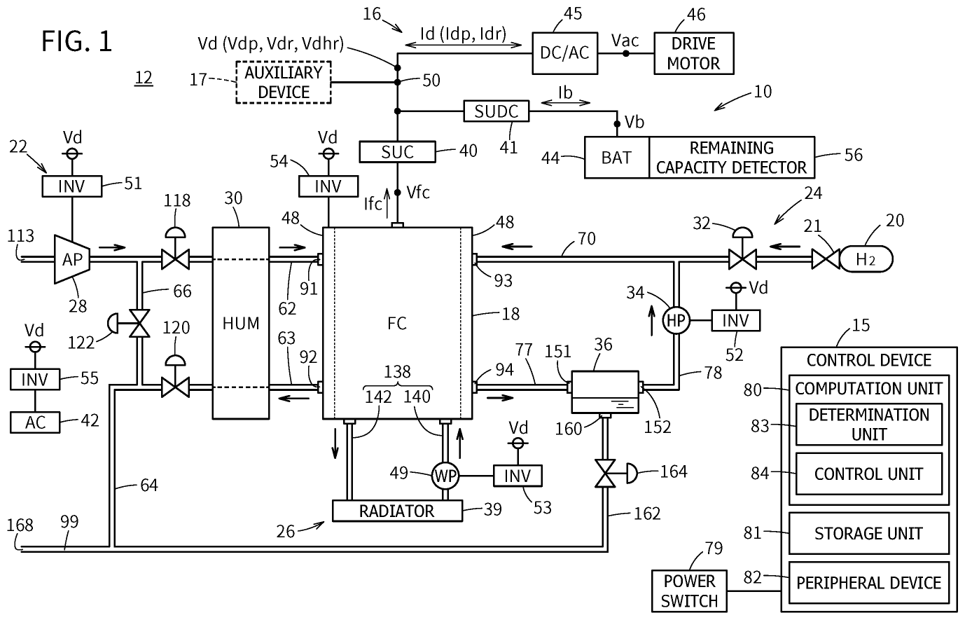

FIG. 1 is a schematic configuration diagram of a fuel cell vehicle 12 according to an embodiment of the present invention, into which a fuel cell system 10 is incorporated.

In addition to the fuel cell vehicle 12, the fuel cell system 10 can also be incorporated into other moving objects such as ships, flying bodies or the like, and robots or the like.

The fuel cell vehicle 12 includes a control device 15 for controlling the entire fuel cell vehicle 12, the fuel cell system 10, and a main load (load of a main device) 16 electrically connected to the fuel cell system 10, and auxiliary devices (auxiliary loads) 17 of the fuel cell system 10.

The control device 15 need not necessarily be a single control device, but may be divided into two or more control devices, for example, the ones respectively used for the fuel cell system 10, the main load 16, the auxiliary devices 17, and the like.

The main load 16 includes a direct-current-to-alternating-current (DC/AC) converter 45 and a drive motor 46. The fuel cell vehicle 12 travels due to a driving force generated by the drive motor 46. The power sources of the fuel cell vehicle 12 are a fuel cell stack (also referred to as a fuel cell) 18 and a power storage device (BAT) 44 that is a secondary battery such as a lithium ion battery.

The auxiliary devices 17 include an air pump (AP) 28, a circulation pump (HP) 34, a coolant pump (WP) 49, an air conditioner (AC: temperature control device) 42, and a heater (temperature control device) 48. The air pump 28 supplies an oxygen-containing gas to the fuel cell stack 18. The circulation pump 34 supplies the fuel off gas containing unreacted fuel gas to the fuel cell stack 18. The coolant pump 49 circulates and supplies a coolant (heat exchange medium) to the fuel cell stack 18. The air conditioner 42 adjusts the temperature of the cabin of the fuel cell vehicle 12 (vehicle). The heater 48 heats ends of the fuel cell stack 18 by induction heating. Each of the auxiliary devices 17 described here consumes relatively large electrical energy.

The fuel cell system 10 includes a step-up converter (SUC) 40 that increases a voltage Vfc generated by the fuel cell stack 18 to a motoring voltage Vdp at the direct-current terminal, which is a DC terminal voltage Vd. In order to increase a regenerative voltage at the AC terminal Vac generated by the drive motor 46 to a high regenerative voltage at the DC terminal Vdhr, the step-up converter 40 increases the generated voltage Vfc to a high voltage the same as the DC terminal Vdhr.

The fuel cell system 10 also includes a step-up/step-down converter (SUDC) 41. The step-up/step-down converter 41 first increases the power storage voltage Vb of the power storage device 44 to a motoring voltage at the DC terminal Vdp, which is a voltage at the DC terminal Vd. The step-up/step-down converter 41 secondly steps down the voltage at the DC terminal Vd to the power storage voltage Vb to charge the power storage device 44. The step-up/step-down converter 41 thirdly decreases the motoring voltage at the DC terminal Vdp, which is obtained by increasing the generated voltage Vfc by the step-up converter 40, to the power storage voltage Vb for charging the power storage device 44. Fourth, the step-up/step-down converter 41 decreases a regenerative voltage at the DC terminal Vdr or the high regenerative voltage at the DC terminal Vdhr to the power storage voltage Vb for charging the power storage device 44.

The DC/AC converter 45 converts the DC terminal motoring voltage Vdp into a three phase AC terminal voltage (AC terminal motoring voltage) Vac and applies the AC terminal voltage Vac to the drive motor 46.

A three phase AC terminal voltage (AC terminal regenerative voltage) Vac generated by the drive motor 46 during regeneration operation is converted into a DC terminal regenerative voltage Vdr or a DC terminal high regenerative voltage Vdhr by the DC/AC converter 45. The DC terminal voltage Vd (the DC terminal motoring voltage Vdp, the DC terminal regenerative voltage Vdr, and the DC terminal high regenerative voltage Vdhr) is applied to the auxiliary devices 17.

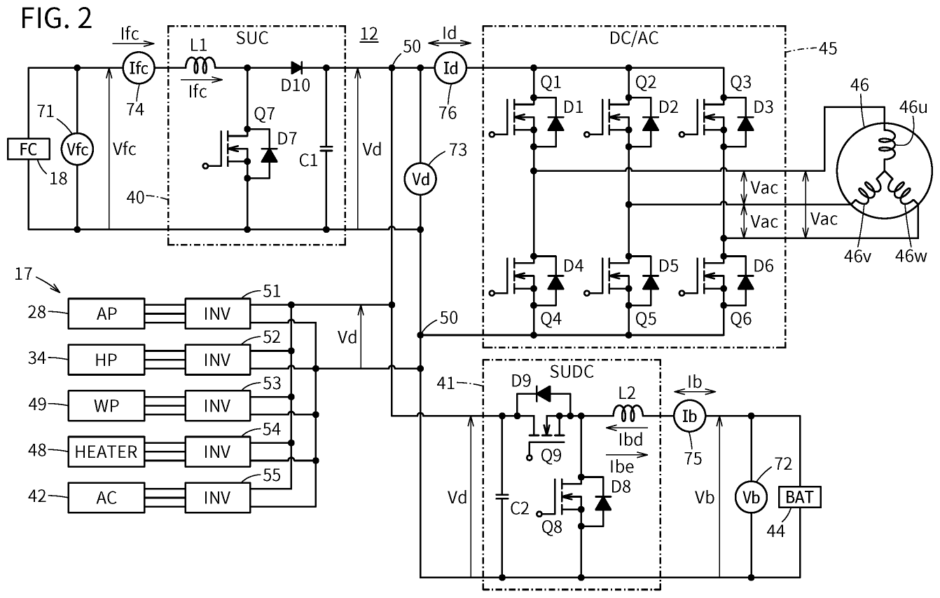

FIG. 2 is an electric circuit diagram of the fuel cell vehicle 12 including a circuit configuration example of the step-up converter 40 that outputs a DC terminal voltage Vd, the step-up/step-down converter 41 that inputs and outputs the DC terminal voltage Vd, and a DC/AC converter 45.

The step-up converter 40 includes a reactor L1, a diode D10, a switching element Q7 with which a reverse diode D7 is connected in parallel, and a smoothing capacitor C1. The step-up converter 40 controls the on/off of the generated current Ifc flowing through the reactor L1 by the switching element Q7 at a high-frequency of a period T. In this case, as shown in the equation (1), the ON time ton in the period T is controlled to increase the generated voltage Vfc to the DC terminal voltage Vd.

$$Vd = [ 1 / ( 1 - ( ton / T ) ) ] \times Vfc \qquad ( 1 )$$

The step-up/step-down converter 41 includes a reactor L2, a switching element Q8 with which a reverse diode D8 is connected in parallel, a switching element Q9 with which a reverse diode D9 is connected in parallel, and a smoothing capacitor C2.

For increasing the power storage voltage Vb, the on/off of the battery current Ib flowing through the reactor L2 is controlled by the switching element Q8 at a high-frequency of the period T, as in the step-up converter 40. In this case, as shown in the equation (2), the ON time ton in the period T is controlled to increase the power storage voltage Vb to the DC terminal voltage Vd.

$$Vd = [ 1 / ( 1 - ( ton / T ) ) ] \times Vb \qquad ( 2 )$$

When the DC terminal voltage Vd is stepped down, the ON time ton of the switching element Q9 in the period T is controlled. In this case, as shown in the equation (3), the DC terminal voltage Vd is stepped down to the power storage voltage Vb.

$$Vb = ( ton / T ) \times Vd \qquad ( 3 )$$

In the DC/AC converter 45, the switching elements Q1 to Q6 and the diodes D1 to D6 connected in the reverse direction to the switching elements Q1 to Q6 are connected in a three phase full-bridge configuration, and the middle points of the upper arm elements of the switching element Q1 and the diode D1, the switching element Q2 and the diode D2, and the switching element Q3 and the diode D3, and the lower arm elements of the switching element Q4 and the diode D4, the switching element Q5 and the diode D5, and the switching element Q6 and the diode D6 are connected respectively to the U-phase coil 46u, the V-phase coil 46v, and the W-phase coil 46w of the three UVW phases of the drive motor 46.

The switching elements Q1 to Q6 are MOSFETs, and are turned on and off based on a PWM (pulse-width modulation) signal applied to gate terminals, and an on time within a predetermined period is controlled. The switching elements may be switching elements other than the MOSFETs.

In the case of motoring operation, the DC/AC converter 45 converts the DC terminal voltage Vd, which is a motoring voltage, into a three phase AC terminal voltage Vac, which is a motoring voltage, and applies the three phase AC terminal voltage Vac to the U-phase coil 46u, the V-phase coil 46v, and the W-phase coil 46w of the drive motor 46.

In the case of regenerative operation, the DC/AC converter 45 converts the three phase AC regenerative voltage Vac generated at the U-phase coil 46u, the V-phase coil 46v, and the W-phase coil 46w of the drive motor 46 into a DC terminal regenerative voltage Vdr, which is a regenerative voltage.

The DC terminal voltage Vd is converted into an AC terminal voltage via the inverters 51 to 55. The AC terminal voltage is applied to the motor of the air pump 28, the motor of the circulation pump 34, the motor of the coolant pump 49, the induction coil of the heater 48, and the compressor of the air conditioner 42. As a result, the motor of the air pump 28, the motor of the circulation pump 34, the motor of the coolant pump 49, the induction coil of the heater 48, and the compressor of the air conditioner 42 are driven.

Although the circuit connections of the inverters 51 to 55 are different in specifications from the switching elements Q1 to Q6 and the diodes D1 to D6 of the DC/AC converter 45, the circuit components and connections are the same as those of the DC/AC converter 45, and thus the description thereof will be omitted. In order to avoid confusion, the switching elements Q1 to Q6 constituting the inverters 51 to 55 will be described as switching elements Q1′ to Q6′ (not shown), and similarly, the diodes D1 to D6 constituting the inverters 51 to 55 will be described as diodes D1′ to D6′ (not shown).

The DC/AC converter 45 may be referred to as a “motor inverter 45”, and the inverters 51 to 55 may be referred to as “auxiliary device inverters 51 to 55” in order to distinguish them from the motor inverter 45.

A voltage detection unit 71 that detects a generated voltage Vfc is connected in parallel with the fuel cell stack 18, and a current detection unit 74 that detects a generated current Ifc, is connected in series with the fuel cell stack 18.

A voltage detection unit 72 that detects the power storage voltage Vb is connected in parallel with the power storage device 44, and a current detection unit 75 that detects a battery current Ib is connected in series with the power storage device 44. The battery current Ib is a discharge current Ibd or a charge current Ibe.

A voltage detection unit 73 that detects a DC terminal voltage Vd is connected between DC terminals (a reference voltage terminal and a voltage terminal) 50 of the DC/AC converter 45, and a current detection unit 76 that detects a DC terminal current Id is connected to the DC terminals 50 of the DC/AC converter 45.

The DC terminal current Id is a motoring current Idp supplied to the drive motor 46 or a regenerative current Idr supplied from the drive motor 46. The voltage generated between two phases of the three phase alternating current of the drive motor 46 is referred to as the AC terminal voltage (AC terminal motoring voltage and AC terminal regenerative voltage) Vac as described above.

Referring back to FIG. 1, the power storage device 44 is provided with a remaining capacity detection unit 56 that measures a remaining capacity SOC, which corresponds toa state of charge [%] of the power storage device 44.

The fuel cell system 10 includes a fuel cell stack 18, a hydrogen tank (fuel gas tank) 20, an oxygen-containing gas supply device 22, a fuel gas supply device 24, and a coolant supply device 26. In the fuel cell stack 18, a plurality of power generation cells (not shown) are stacked. The oxygen-containing gas supply device 22 includes an air pump (AP) 28 and a humidifier (HUM) 30.

The fuel gas supply device 24 includes a pressure reducing valve 32, a circulation pump 34, and a gas-liquid separator 36. The pressure reducing valve 32 may be replaced with an injector. The circulation pump 34 may be replaced with an ejector. The coolant supply device 26 includes a coolant pump (WP) 49 and a radiator 39.

The air pump 28 is configured by a mechanical supercharger or the like driven by a compressor motor which is controlled by the three-phase alternating-current output of the inverter 51.

The air pump 28 includes functions such as drawing in and pressurizing external air (the atmosphere, air) from an external air intake hole 113, pressurizing the air, and supplying the pressurized air to the fuel cell stack 18 through the humidifier 30.

The humidifier 30 has a function of humidifying the oxygen-containing gas supplied from the air pump 28. More specifically, the humidifier 30 causes water contained within the oxygen-containing exhaust gas (oxygen-containing off-gas) discharged from an oxygen-containing off-gas outlet to move to the gas (the oxygen-containing gas) to be supplied via an internal porous membrane, and thereby humidifies the gas to be supplied, and in addition, supplies the humidified oxygen-containing gas to the fuel cell stack 18 through an oxygen-containing gas inlet 91.

In an oxygen-containing gas supply flow path 62 extending from the external air intake hole 113 to the oxygen-containing gas inlet 91, the air pump 28, an inlet-side sealing valve 118, and the humidifier 30 are provided in this order from the external air intake hole 113. Moreover, it should be noted that the flow paths such as the oxygen-containing gas supply flow path 62 and the like, which are drawn with double lines, are formed by piping (the same feature applies hereinafter). The inlet-side sealing valve 118 opens and closes the oxygen-containing gas supply flow path 62.

In an oxygen-containing off-gas discharge flow path 63 that communicates with an oxygen-containing off gas outlet 92, there are provided in this order from the oxygen-containing off gas outlet 92, the humidifier 30, and an outlet side sealing valve 120 that also functions as a back pressure valve.

A bypass flow path 66, which places the oxygen-containing gas supply flow path 62 in communication with the oxygen-containing off-gas discharge flow path 63, is provided between a suction port of the inlet side sealing valve 118 and a discharge port of the outlet side sealing valve 120. A bypass valve 122 that opens and closes the bypass flow path 66 is provided in the bypass flow path 66. The bypass valve 122 adjusts the flow rate of the oxygen-containing gas bypassing the fuel cell stack 18. A merging flow path between the bypass flow path 66 and the oxygen-containing off-gas discharge flow path 63 communicates with a discharge flow path 64.

The hydrogen tank 20 is a container including a solenoid shut-off valve 21, and compresses highly pure hydrogen under high pressure, and stores the compressed hydrogen.

The fuel gas (hydrogen) discharged from the hydrogen tank 20 is reduced in pressure through a pressure reducing valve 32 provided in a fuel gas supply flow path 70, and is supplied to a fuel gas inlet 93 of the fuel cell stack 18.

The fuel off-gas outlet 94 of the fuel cell stack 18 is in communication with an inlet 151 of the gas-liquid separator 36 through a fuel off-gas discharge flow path 77, and the fuel off-gas as a remainder of the hydrogen-containing gas is fed from the fuel cell stack 18 to the inlet 151.

The gas component of the fuel off-gas is discharged from a gas outlet 152 of the gas-liquid separator 36, is caused to pass through a circulation flow path 78 by the circulation pump 34, and is supplied to the fuel gas supply flow path 70. The fuel off-gas supplied to the fuel gas supply flow path 70 merges with the fuel gas discharged from the pressure reducing valve 32, and is supplied from the fuel gas inlet 93 into the fuel cell stack 18.

The liquid component (liquid water) of the fuel off-gas passes from a liquid outlet 160 of the gas-liquid separator 36 and through a drain flow path 162 in which a drain valve 164 is provided, is mixed with the discharged gas that is discharged from the discharge flow path 64, and is discharged into the external air through a discharge flow path 99 and a discharge gas exhaust port 168.

A portion of the fuel off-gas (a hydrogen-containing gas) is discharged into the drain flow path 162 together with the liquid water. Further, after discharging of the liquid water is completed, a situation is brought about in which only the fuel off-gas (the hydrogen-containing gas) is discharged into the drain flow path 162.

In order to dilute the hydrogen gas within the fuel off-gas before discharging it to the exterior, a portion of the oxygen-containing gas discharged from the air pump 28 passes through the bypass flow path 66, and is supplied to the discharge flow path 64.

In the case that the drain valve 164 continues to be opened even after the water has drained from the drain flow path 162, then after the water has been drained from the gas-liquid separator 36, the drain valve 164 is appropriately closed.

The coolant supply device 26 of the fuel cell system 10 includes a coolant flow path 138 through which a cooling medium (coolant) flows. The coolant flow path 138 includes a coolant supply flow path 140 and a coolant discharge flow path 142. The coolant is supplied to the fuel cell stack 18 through the supply flow path 140, and the coolant from the coolant flow path 138 of the fuel cell stack 18 is discharged through the coolant discharge flow path 142. The radiator 39 is connected to the coolant supply flow path 140 and the coolant discharge flow path 142.

The radiator 39 serves to cool the coolant. The coolant supply flow path 140 is provided with the coolant pump 49. The coolant pump 49 causes the coolant to circulate inside a coolant circulation circuit. The coolant supply flow path 140, an internal coolant flow path of the fuel cell stack 18, the coolant discharge flow path 142, and the radiator 39 are included in the coolant circulation circuit. The above-described components of the fuel cell system 10 are collectively controlled by the control device 15.

Moreover, it should be noted that, although the inlet side sealing valve 118, the outlet side sealing valve 120, the bypass valve 122, and the drain valve 164 are flow rate adjustment valves the valve openings of which are controlled by the control device 15, the duty thereof may also be controlled using electromagnetic control type ON/OFF valves.

The control device 15 is a computer provided in the fuel cell vehicle 12. The control device 15 includes a computation unit 80, a storage unit 81, a peripheral device 82, and a display unit (not shown) and an operation unit (not shown) connected to the peripheral device 82.

The computation unit 80 may be constituted by a processor such as a CPU, a GPU, or the like. More specifically, the computation unit 80 can be configured by a processing circuitry.

The computation unit 80 comprises a determination unit 83 and a control unit 84. The determination unit 83, and the control unit 84 can be realized by the computation unit 80 executing programs which are stored in the storage unit 81.

The peripheral device 82 performs processing such as measuring time and converting an analog signal into digital data to be taken in, in addition to input/output processing of digital data with the components constituting the fuel cell vehicle 12.

Moreover, at least a portion of the peripheral device 82, the determination unit 83, and the control unit 84 may be realized by an integrated circuit such as an ASIC, an FPGA, or the like. Further, at least a portion of the peripheral device 82, the determination unit 83, and the control unit 84 may be constituted by an electronic circuit including a discrete device.

The storage unit 81 may be constituted by a volatile memory and a non-volatile memory. As the volatile memory, for example, a RAM or the like may be cited. The volatile memory is used as a working memory of the processor, and temporarily stores data or the like required for processing or calculations. As the non-volatile memory, there may be cited a ROM and a flash memory. The non-volatile memory is used as a storage memory, and serves to store a program, a table, a map, and the like. At least a portion of the storage unit 81 may be provided in the processor, the integrated circuit, or the like, in the manner described above.

The computation unit 80 of the control device 15, by executing calculations in accordance with the program, perform controls such as a control of operations of the fuel cell vehicle 12 and the fuel cell system 10.

A power switch (power source SW) 79 of the fuel cell vehicle 12 is connected to the control device 15. The power switch 79 causes an electrical power driving operation of the fuel cell stack 18 of the fuel cell system 10 to be started or continued (ON), or to be ended (OFF). The control device 15 is also connected to an unillustrated accelerator operation amount detection unit that detects an operation amount of an accelerator pedal and an unillustrated vehicle speed detection unit that detects a vehicle speed of the fuel cell vehicle 12.

### Operation

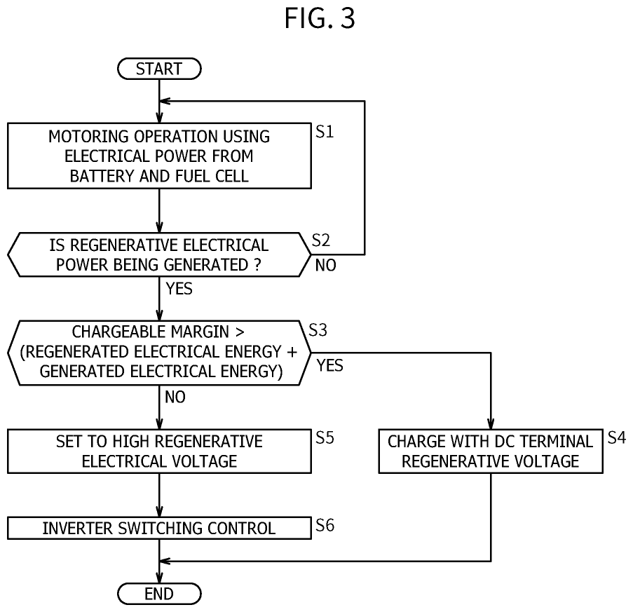

The fuel cell vehicle 12 according to the present embodiment is basically configured in the manner described above. Hereinafter, the electrical power processing operation during the motoring operation and the regenerative operation will be described with reference to the flowchart of FIG. 3, taking the forward running of the fuel cell vehicle 12 as an example.

At step S1, the control device 15 performs the motoring operation. In this case, the control device 15 calculates the DC terminal voltage Vd and the motoring current Idp input to the DC/AC converter 45 based on the accelerator operation amount by the user and the vehicle speed during traveling. Here, the DC terminal voltage Vd×the motoring current Idp is referred to as motoring operation required electrical power Pp (Pp=Vd×Idp). Further, the control device 15 calculates auxiliary device required electrical power Pa of the auxiliary device 17 corresponding to the motoring operation required electrical power Pp and the like.

Further, the control device 15 determines the electrical energy generated by the fuel cell stack 18 and the electrical energy discharged from the power storage device 44 for distribution to cover the motoring operation required electrical power Pp and the auxiliary device required electrical power Pa.

The control device 15 determines the fuel gas pressure and the oxygen-containing gas pressure applied to the fuel cell stack 18 for the fuel cell stack 18 to generate electrical power, and controls the air pump 28 and the pressure reducing valve 32 to perform electrical power generation control.

The control device 15 increases the generated voltage Vfc to the DC terminal motoring voltage Vdp using the step-up converter 40 and applies the DC terminal motoring voltage Vdp to the DC terminal 50 of the DC/AC converter 45. As necessary, the control device 15 increases the power storage voltage Vb to the DC terminal motoring voltage Vdp using the step-up/step-down converter 41 and applies the DC terminal motoring voltage Vdp to the DC terminal 50 of the DC/AC converter 45.

The control device 15 controls switching of the DC/AC converter 45 so that the drive motor 46 has a rotational speed corresponding to the vehicle speed. In this way, the control device 15 performs the motoring operation on the drive motor 46, and advances the process to step S2.

In step S2, the determination unit 83 of the control device 15 determines whether or not the drive motor 46 of the fuel cell vehicle 12 is generating regenerative electrical power.

While the accelerator operation by the user is continued, that is, when the accelerator operation amount is being detected, the regenerative electrical power is not generated (S2: NO), and thus the motoring operation in the step S1 is continued.

On the other hand, when the accelerator operation amount by the user becomes zero on a downhill slope or the like, the current detection unit 76 detects that the regenerative current Idr flows from the DC/AC converter 45 (S2: YES).

In step S2, the control device 15 estimates regenerated electrical energy [kWh] at present by using, for example, an unillustrated navigation device or the like.

In step S2, in the case where the determination unit 83 of the control device 15 makes a positive determination (S2: YES) that regenerative electrical power is being generated during regenerative operation, the determination unit 83 advances the process to step S3.

In step S3, the determination unit 83 of the control device 15 determines whether or not the increment obtained by adding the generated electrical energy to the regenerated electrical energy is less than the chargeable margin as shown in the equation (4): Chargeable Margin>(Regenerated Electrical Energy+Generated Electrical Energy) [kWh] (4). In this case, the control device 15 acquires the remaining capacity SOC [kWh] of the power storage device 44 from the remaining capacity detector 56.

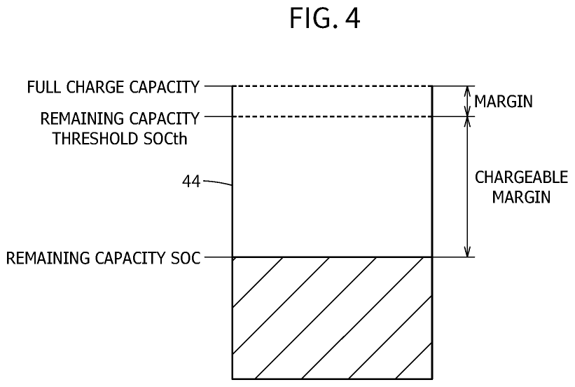

FIG. 4 is a schematic diagram illustrating a remaining capacity SOC or the like of the power storage device 44. With respect to the full charge capacity of the power storage device 44, the hatched area indicates the remaining capacity SOC.

For protection of the power storage device 44, the remaining capacity threshold SOCth serving as the upper limit of the remaining capacity SOC is set to a value obtained by subtracting a margin from the full charge capacity.

A difference obtained by subtracting the remaining capacity SOC from the remaining capacity threshold SOCth is the chargeable margin. This relationship is expressed by the following equations (5) and (6).

$$( 5 )$$

$$Chargeable Margin = Remaining Capacity Threshold SOCth - Remaining Capacity SOC$$

$$( 6 )$$

$$Remaining Capacity Threshold SOCth = Remaining Capacity SOC + Chargeable Margin$$

In step S3, in the case of positive determination(S3: YES), that is, in the case where the chargeable margin is larger than “Regenerated Electrical Energy+Generated Electrical Energy”, the control device 15 advances the process to step S4.

In step S4, the control device 15 sets the DC terminal voltage Vd to the normal DC terminal regenerative voltage Vdr corresponding to the AC terminal regenerative voltage Vac, decreases the DC terminal regenerative voltage Vdr to the power storage voltage Vb using the step-up/step-down converter 41 to charge the power storage device 44, and the current processing is brought to an end.

On the other hand, if the determination in step S3 is negative (S3: NO), the control device 15 advances the process to step S5.

In step S5 (high regenerative voltage generation step), the control device 15 calculates a surplus of electrical energy that is greater than the remaining capacity threshold SOCth, and calculates a high DC terminal regenerative voltage Vdhr that is higher than a normal DC terminal regenerative voltage Vdr corresponding to the AC terminal regenerative voltage Vac, in order to consume (curtail) the surplus power with the switching elements of the inverters 51 to 55.

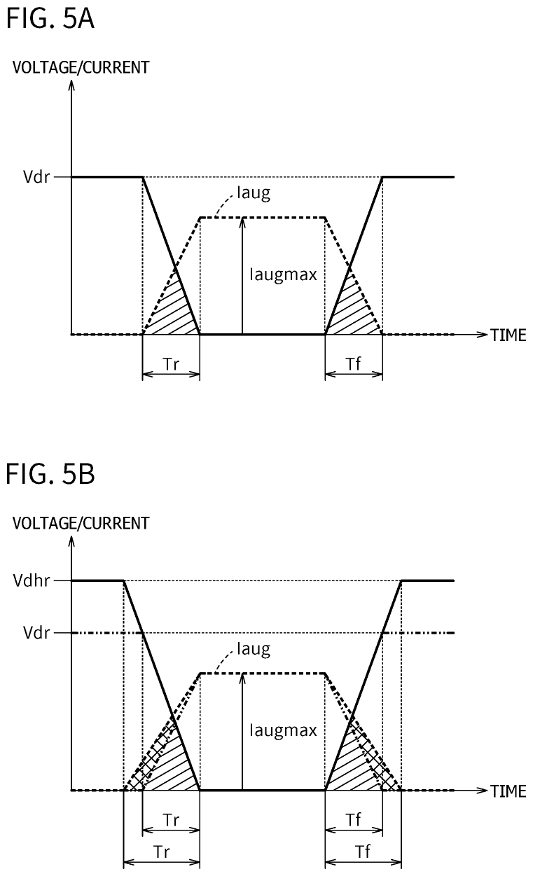

FIGS. 5A and 5B are diagrams for facilitating understanding. The hatched regions in FIGS. 5A and 5B indicate the switching loss of the inverters 51 to 55 at the normal DC terminal regenerative voltage Vdr. The cross-hatched regions in FIG. 5B indicate the switching loss of the surplus power at the high DC terminal regenerative voltage Vdhr, corresponding to the surplus energy that needs to be curtailed.

In this case, the switching loss can be increased by the cross-hatched regions by increasing the DC terminal voltage Vd to the high DC terminal regenerative voltage Vdhr by the step-up converter 40 or the step-up/step-down converter 41.

The switching loss Psw can be calculated by the following equation (7): Psw=(1/6)×Iaugmax×Vd×(Tr+Tf)×fsw (7). As described above, the switching loss Psw in the hatched regions is a switching loss in the case of Vd =Vdr. The switching loss in the cross-hatched regions corresponds to a difference obtained by subtracting the switching loss Psw (hatched regions) at Vd=Vdr from the switching loss Psw (hatched regions+cross-hatched regions) at Vd=Vdhr.

The Meanings of the Respective Signs in the Equation (7) are as follows:

Iaugmax: Maximum value of drain current indicated by broken line in the case where switching elements constituting the inverters 51 to 55 are in ON state;

Vd: DC terminal voltage, which is a maximum value of a drain-source voltage of the switching elements, as a DC terminal regenerative voltage Vdr or a high DC terminal regenerative voltage Vdhr here;

Tr: Rise time of switching element;

Tf: Fall time of switching element; and

fsw: Switching frequency.

In step S6 (auxiliary device driving step), the control device 15 performs the switching control of the inverters 51 to 55 with the setting of the high DC terminal regenerative voltage Vdhr.

According to the above embodiment, since the high DC terminal regenerative voltage Vdhr is applied to the DC terminals of the switching elements constituting the inverters 51 to 55 by the processing of step S6, the loss of the switching elements constituting the inverters 51 to 55 increases by the cross-hatched regions (FIG. 5B). Due to the loss corresponding to the cross-hatched regions, the surplus regenerative electrical power that cannot be charged to the power storage device 44 is curtailed (consumed). By curtailing the regenerative electrical power, the drive motor 46 can efficiently apply regenerative braking. The cross-hatched regions are repeatedly generated for six switching elements (5×6=30) constituting each of the inverters 51 to 55.

According to the above embodiment, in the case where the determination unit 83 determines that the remaining capacity SOC of the power storage device 44 becomes equal to or higher than the remaining capacity threshold SOCth by charging the power storage device 44 with the regenerative electrical power through the processing of steps S3 to S6, in other words, in a situation where the power storage device 44 cannot be charged with all of the regenerative electrical power, the high DC terminal regenerative voltage Vdhr is applied to the DC terminals of the switching elements constituting the inverters 51 to 55. Therefore, the loss of the switching elements increases by an amount corresponding to the cross-hatched regions in FIG. 5B, and this increase in the loss enables the surplus regenerative electrical power that cannot be charged to the power storage device 44 to be curtailed. In this manner, the drive motor 46 can efficiently apply regenerative braking.

According to the above embodiment, the high DC terminal regenerative voltage Vdhr is applied to the DC input terminals of the inverters 51 to 55 that drive the auxiliary devices 17 that have relatively large power consumption by the processing of steps S5 and S6. Therefore, even relatively large regenerative electrical power can be effectively curtailed by the switching loss of the inverters 51 to 55 that drive the auxiliary devices 17. In this manner, the drive motor 46 can efficiently apply regenerative braking.

Furthermore, according to the above embodiment, in the case where the sum of the regenerated electrical energy and the generated electrical energy is less than the chargeable margin of the power storage device 44 (S3: YES), the DC terminal regenerative voltage Vdr converted through the DC/AC converter 45 is decreased to the power storage voltage Vb by the step-up/step-down converter 41, and the regenerative electrical power is charged to the power storage device 44. On the other hand, in the case where the sum of the regenerated electrical energy and the generated electrical energy is equal to or greater than the chargeable margin of the power storage device 44, the step-up/step-down converter 41 is brought to a non-operating (stopped) state, and the surplus regenerative electrical power can be curtailed using the inverters 51 to 55 of the auxiliary devices 17. In this case, the drive motor 46 can efficiently apply regenerative braking.

### Supplementary Note

In relation to the above-described disclosure, the following supplementary notes are further disclosed.

### Supplementary Note 1

The fuel cell vehicle (12) of the present disclosure includes the direct-current-to-alternating-current converter (45), the fuel cell (18), the step-up converter (SUC) configured to increase a generated voltage of the fuel cell (Vfc) to generate a motoring voltage at a direct-current terminal (Vdp) of the direct-current-to-alternating-current converter, the power storage device (44), the step-up and step-down converter (41) configured to increase a power storage voltage (Vb) of the power storage device to generate a motoring voltage at the direct-current terminal (Vdp), and the drive motor (46) configured to perform motoring operation upon application of a motoring voltage at an alternating-current terminal (Vacp) obtained by converting the motoring voltage at the direct-current terminal into the motoring voltage at the alternating-current terminal by the direct-current-to-alternating-current converter, wherein the fuel cell vehicle charges the power storage device with the regenerative voltage at the direct-current terminal (Vdr) that is converted from a regenerative voltage at the alternating-current terminal (Vacr) generated at the drive motor during regenerative operation through the direct-current-and-alternating-current converter and decreased by the step-up and step-down converter, or with a voltage at the direct-current terminal that is increased from the generated voltage after being increased by the step-up converter and decreased by the step-up and step-down converter, the fuel cell vehicle (12) includes the auxiliary device (17) driven via the inverter (51 to 55) to which the motoring voltage at the direct-current terminal during the motoring operation or the regenerative voltage at the direct-current terminal during the regenerative operation is applied, wherein during the regenerative operation, the regenerative voltage generated at the alternating-current terminal of the drive motor is converted, through the direct-current-and-alternating-current converter, into a regenerative voltage at the direct-current terminal, and increased by the step-up converter or the step-up and step-down converter to a high regenerative voltage (Vdhr) that is higher than the regenerative voltage at the direct-current terminal, and the high regenerative voltage is applied to the inverter configured to drive the auxiliary device.

According to such a configuration, the regenerative voltage (AC terminal regenerative voltage) generated by the drive motor is increased to the DC terminal high regenerative voltage by the step-up converter or the step-up/step-down converter, and the DC terminal high regenerative voltage is applied to the inverters that drive the auxiliary devices. Here, the high regenerative voltage at the direct-current terminal refers to a DC voltage higher than a normal DC terminal regenerative voltage obtained by converting, by the DC/AC converter, the AC terminal regenerative voltage generated by the drive motor during regenerative operation. Thus, since the high regenerative voltage at the DC terminal is applied to the DC terminal of the switching elements of the inverters for driving the auxiliary devices, the loss of the switching elements constituting the inverter increases, and this loss enables curtailment of the surplus regenerative electrical power that cannot be charged into the power storage device. As a result, the regenerative brake by the drive motor can be efficiently applied.

### Supplementary Note 2

The fuel cell vehicle according to Supplementary Note 1 may further include a determination unit (83) configured to determine whether or not to increase the regenerative voltage at the direct-current terminal to a high regenerative voltage at the direct-current terminal, wherein the determination unit may determine to increase the regenerative voltage at the direct-current terminal to the high regenerative voltage at the direct-current terminal in the case where a remaining capacity (SOC) of the power storage device is equal to or greater than a remaining capacity threshold (SOCth), and may determine not to increase the regenerative voltage at the direct-current terminal to the high regenerative voltage at the direct-current terminal in the case where the remaining capacity of the power storage device is less than the remaining capacity threshold.

According to such configuration, in the case where the determination unit determines that the remaining capacity of the power storage device is equal to or higher than the remaining capacity threshold, in other words, in a situation where the power storage device cannot be charged with the regenerative electrical power of the drive motor, the high DC terminal regenerative voltage Vdhr is applied to the DC terminals of the switching elements constituting the inverters. Therefore, the loss of the switching elements constituting the inverters increases, and this increase in the loss enables the surplus regenerative electrical power that cannot be charged to the electric storage device to be curtailed. As a result, the regenerative brake by the drive motor can be efficiently applied.

### Supplementary Note 3

In the fuel cell vehicle according to Supplementary Note 1 or 2, the auxiliary device may include at least one of the oxygen-containing gas supply pump (28) configured to supply oxygen-containing gas to the fuel cell, the fuel gas circulation pump (34) configured to supply a fuel off-gas to the fuel cell, the coolant pump (49) configured to circulate and supply a coolant to the fuel cell, and a heater configured to warm up the fuel cell.

According to such a configuration, since the high regenerative voltage can be applied to the DC terminals of the inverters of the auxiliary devices having a relatively large power consumption, even a relatively large regenerative electrical power can be effectively curtailed by the switching loss of the inverters that drive the auxiliary devices. As a result, the drive motor can efficiently apply regenerative braking.

### Supplementary Note 4

In the fuel cell vehicle according to Supplementary Note 1 or 2, the auxiliary device may be the temperature control device (42) configured to control a temperature of a cabin of the vehicle.

Since the temperature control device that controls the temperature of the cabin of the vehicle consumes relatively large electrical energy, the temperature control device is operated preferentially by the high regenerative voltage at the time of regeneration operation under a situation where the operation of the temperature control device is required, so that the regenerative electrical power can be effectively wasted by the switching loss of the inverter that drives the temperature control device. As a result, the drive motor can efficiently apply regenerative braking.

### Supplementary Note 5

In the fuel cell vehicle according to Supplementary Note 2, in the case where the determination unit determines that the remaining capacity of the power storage device is less than the remaining capacity threshold and the regenerative voltage at the direct terminal is not to be increased to the high regenerative voltage, the regenerative voltage at the direct terminal converted through the direct-current-to-alternating-current converter may be decreased to the power storage voltage by the step-up and step-down converter to charge the power storage device.

In this manner, since the regenerative electrical power is charged in the electric storage device, the regenerative electrical power can be effectively used without being wasted, and regenerative braking by the drive motor can be efficiently applied.

### Supplementary Note 6

A regenerative electrical power consumption method of the present disclosure for a fuel cell vehicle, the fuel cell vehicle including a direct-current-to-alternating-current converter (45), a fuel cell (18), a step-up converter (SUC) configured to increase a generated voltage of the fuel cell (Vfc) to generate a motoring voltage at a direct-current terminal (Vdp) of the direct-current-to-alternating-current converter, a power storage device (44), a step-up and step-down converter (41) configured to increase a power storage voltage (Vb) of the power storage device to generate a motoring voltage at the direct-current terminal (Vdp), and a drive motor (46) configured to perform motoring operation upon application of a motoring voltage at an alternating-current terminal (Vacp) obtained by converting the motoring voltage at the direct-current terminal into the motoring voltage at the alternating-current terminal by the direct-current-to-alternating-current converter, wherein the fuel cell vehicle charges the power storage device with the regenerative voltage at the direct-current terminal (Vdr) that is converted from a regenerative voltage at the alternating-current terminal (Vacr) generated at the drive motor during regenerative operation through the direct-current-and-alternating-current converter and decreased by the step-up and step-down converter, or with a voltage at the direct-current terminal that is increased from the generated voltage by the step-up converter and decreased by the step-up and step-down converter, the fuel cell vehicle (12) includes an auxiliary device (17) driven via an inverter (51 to 55) to which the motoring voltage at the direct-current terminal during the motoring operation or the regenerative voltage at the direct-current terminal during the regenerative operation is applied, the method comprising: a high regenerative current generation step of converting, during the regenerative operation, through the direct-current-and-alternating-current converter, the regenerative voltage generated at the alternating-current terminal of the drive motor into a regenerative voltage at the direct-current terminal and increasing the regenerative voltage at the direct-current terminal to a high regenerative voltage (Vdhr) that is higher than the regenerative voltage at the direct-current terminal; and an auxiliary device drive step of driving the auxiliary device by applying the high regenerative voltage to the direct-current terminal of the inverter to increase a switching loss of the inverter.

According to the present disclosure, the regenerative voltage (regenerative voltage at the alternating-current terminal) generated by the drive motor is increased to the high regenerative voltage at the direct-current terminal by the step-up converter or the step-up/step-down converter, and the high regenerative voltage at the direct current terminal is applied to the inverter that drives the auxiliary device. Here, the high regenerative voltage at the direct-current terminal refers to a DC voltage higher than a normal DC terminal regenerative voltage obtained by converting, by the DC/AC converter, the AC terminal regenerative voltage generated by the drive motor during regenerative operation. Thus, since the high regenerative voltage at the DC terminal is applied to the DC terminal of the switching element of the inverter for driving the auxiliary devices, the loss of the switching elements constituting the inverter increases, and this loss enables curtailment of the surplus regenerative electrical power that cannot be charged into the power storage device. As a result, the regenerative brake by the drive motor can be efficiently applied.

The present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell vehicle comprising:
a direct-current-to-alternating-current converter;
a fuel cell;
a step-up converter configured to increase a generated voltage of the fuel cell to generate a motoring voltage at a direct-current terminal of the direct-current-to-alternating-current converter;
a power storage device;
a step-up and step-down converter configured to increase a power storage voltage of the power storage device to generate a motoring voltage at the direct-current terminal;
a drive motor configured to perform motoring operation upon application of a motoring voltage at an alternating-current terminal obtained by converting the motoring voltage at the direct-current terminal into the motoring voltage at the alternating-current terminal by the direct-current-to-alternating-current converter;
an auxiliary device driven via an inverter to which the motoring voltage at the direct-current terminal during the motoring operation or the regenerative voltage at the direct-current terminal during the regenerative operation is applied; and
one or more processors that execute computer-executable instructions stored in a memory,
wherein the one or more processors execute the computer-executable instructions to cause the fuel cell vehicle to:
charge the power storage device with the regenerative voltage at the direct-current terminal that is converted from a regenerative voltage at the alternating-current terminal generated at the drive motor during regenerative operation through the direct-current-and-alternating-current converter and decreased by the step-up and step-down converter, or with a voltage at the direct-current terminal that is increased from the generated voltage after being increased by the step-up converter and decreased by the step-up and step-down converter;
convert, during the regenerative operation, the regenerative voltage generated at the alternating-current terminal of the drive motor, through the direct-current-and-alternating-current converter, into a regenerative voltage at the direct-current terminal;
increase, using the step-up converter or the step-up and step-down converter, the regenerative voltage generated at the alternating-current terminal of the drive motor toa high regenerative voltage that is higher than the regenerative voltage at the direct-current terminal; and
apply the high regenerative voltage to the inverter configured to drive the auxiliary device.

2. The fuel cell vehicle according to claim 1,
wherein the one or more processors cause the fuel cell vehicle to:
determine to increase the regenerative voltage at the direct-current terminal to the high regenerative voltage at the direct-current terminal in a case where a remaining capacity of the power storage device is equal to or greater than a remaining capacity threshold, and
determine not to increase the regenerative voltage at the direct-current terminal to the high regenerative voltage at the direct-current terminal in a case where the remaining capacity of the power storage device is less than the remaining capacity threshold.

3. The fuel cell vehicle according to claim 1, wherein the auxiliary device includes at least one of an oxygen-containing gas supply pump configured to supply oxygen-containing gas to the fuel cell, a fuel gas circulation pump configured to supply a fuel off-gas to the fuel cell, a coolant pump configured to circulate and supply a coolant to the fuel cell, and a heater configured to warm up the fuel cell.

4. The fuel cell vehicle according to claim 1, wherein the auxiliary device is a temperature control device configured to control a temperature of a cabin of the vehicle.

5. The fuel cell vehicle according to claim 2, wherein the one or more processors cause the fuel cell vehicle to:
decrease the regenerative voltage at the direct terminal, which has been converted through the direct-current-to-alternating-current converter, to the power storage voltage through the step-up and step-down converter to charge the power storage device in a case where it is determined that the remaining capacity of the power storage device is less than the remaining capacity threshold and that the regenerative voltage at the direct terminal is not to be increased to the high regenerative voltage.

6. A regenerative electrical power consumption method for a fuel cell vehicle, the fuel cell vehicle comprising a direct-current-to-alternating-current converter, a fuel cell, a step-up converter configured to increase a generated voltage of the fuel cell to generate a motoring voltage at a direct-current terminal of the direct-current-to-alternating-current converter, a power storage device, a step-up and step-down converter configured to increase a power storage voltage of the power storage device to generate a motoring voltage at the direct-current terminal, and a drive motor configured to perform motoring operation upon application of a motoring voltage at an alternating-current terminal obtained by converting the motoring voltage at the direct-current terminal into the motoring voltage at the alternating-current terminal by the direct-current-to-alternating-current converter,
wherein the fuel cell vehicle charges the power storage device with the regenerative voltage at the direct-current terminal that is converted from a regenerative voltage at the alternating-current terminal generated at the drive motor during regenerative operation through the direct-current-and-alternating-current converter and decreased by the step-up and step-down converter, or with a voltage at the direct-current terminal that is increased from the generated voltage by the step-up converter and decreased by the step-up and step-down converter,
wherein the fuel cell vehicle includes an auxiliary device driven via an inverter to which the motoring voltage at the direct-current terminal during the motoring operation or the regenerative voltage at the direct-current terminal during the regenerative operation is applied,
the method comprising:
converting, during the regenerative operation, through the direct-current-and-alternating-current converter, the regenerative voltage generated at the alternating-current terminal of the drive motor into a regenerative voltage at the direct-current terminal and increasing the regenerative voltage at the direct-current terminal to a high regenerative voltage that is higher than the regenerative voltage at the direct-current terminal; and
driving the auxiliary device by applying the high regenerative voltage to the direct-current terminal of the inverter to increase a switching loss of the inverter.
